(19) United States
(12) Patent Application Publication
(10) Pub. No.: US 2005/0085231 A1
(43) Pub. Date: Apr. 21, 2005

(54) Method for re-routing a communication link inculding several radio communication systems

(76) Inventors: Markus Dillinger, Munchen (DE); Jijun Luo, Munchen (DE)

Correspondence Address: LERNER AND GREENBERG, PA, P O BOX 2480, HOLLYWOOD, FL, 33022-2480, US

(21) Appl. No.: 10/503,881

(22) PCT Filed: Feb. 4, 2003
(86) PCT No.: PCT/DE03/00313

(30) Foreign Application Priority Data
Feb. 5, 2002 (DE) 102 04 624.7

(51) Int. Cl. H04Q 7/20

(52) U.S. Cl. 455/445; 455/444

(57) ABSTRACT

Disclosed is a method for re-routing an existing communication link with a subscriber terminal which comprises devices for communication with several radio communication systems. After a disruption or interruption of an existing communication link to a first radio communication system in an environment including several radio communication systems, an attempt is made to re-route the communication link via at least one other radio communication system.

This invention relates to a method for rerouting an existing communication link with a subscriber terminal, which comprises devices for communication with several radio communication systems.

Situations can always arise in radio communication systems in which the communication links to subscriber terminals cannot be established, or existing communication links are markedly degraded or even interrupted.

GB 2 173 377 describes a method for setting up a communication link to a mobile telephone in a cellular radio communication system with a communication link being established via an adjacent overlapping radio cell of the radio communication system, if in a specific radio cell all radio channels of these radio communication system are already occupied. This method also includes the selection of an alternate communication path within the same radio communication system.

A method of this kind, however, fails if an existing communication link within a radio communication system is heavily degenerated or interrupted, for example due to strong interference in the communication links, such as fading, high mobility of the subscriber terminals or a high traffic load within the radio communication system, and there are no appropriate alternatives within the radio communication system for rerouting the communication link.

The object of this invention is to provide an improved method for rerouting an existing communication link with a subscriber terminal, that guarantees the highest possible degree of security for the rerouting of the communication link.

The object is achieved by the features of the independent patent claims. Advantageous further embodiments of the invention are given in the dependent patent claims.

In this connection, reference is made to subscriber terminals that have devices for communication with several radio communication systems. In accordance with the invention, in an environment with several radio communication systems, a rerouting of the communication link including at least one further radio communication system is attempted after an interruption in the existing communication link to a first radio communication system. Thus, in the context of this invention, advantageous use is made of the possibilities of subscriber terminals that have devices for communication with several radio communication systems, i.e. in the simplest case, dual-mode terminals or in a general case multi-mode terminals.

If an existing link from and/or to a terminal of this kind is disrupted or interrupted within a first radio communication system, an attempt can be made by access to a second or further radio communication systems to reroute the communication link. There is then a greater probability of providing an improved communication path for the rerouting of the communication link, particularly if the available radio communication systems have distinctly different functional differences with regard to the supply the subscriber terminals, such as power supply coverage, transmitter power, transmission capacity, traffic channels etc. The rerouting can then take place completely, or also only partially, through an alternate radio communication system.

Thus, the communication link, e.g. direct from the subscriber terminal to the destination of the communication link, can be rerouted via an alternate radio communication system, but the communication link can also just be rerouted from the subscriber terminal of a suitable switching node of the original radio communication system via an alternate radio communication system and from there, routed onwards in the original radio communication system to the destination of the communication link.

It can preferably be provided that, after a disruption or interruption to the the existing communication link, requests for the rerouting of the communication link can be made in parallel via a first radio communication system and at least one further radio communication system. Thus, several, or all, alternatives can be requested for the rerouting in an efficient manner, in order to serve as a basis for a decision for the rerouting of the communication link, i.e. for a decision regarding the manner in which, and the radio communication system via which the communication link is to be wholly or partially rerouted.

The decision regarding which of the existing radio communication systems is to be used for rerouting the communication link can alternatively or cumulatively be based on different suitable decision parameters. Thus a decision regarding the rerouting of the communication link via at least one further radio communication system can be controlled by time information, i.e. the decision can be based on defined time marks or time durations. Preferably, the decision on the rerouting of the communication link can depend on the time duration up until there is a response from the radio communication systems to the request takes place. Time durations can be specified globally or individually for each radio communication system. If within this time duration there is no positive response from the corresponding radio communication system to a request by the subscriber terminal, a decision on the rerouting of the communication link via an alternate radio communication system can be made.

As an alternative, or in addition to, the aforementioned decision based on time information, the decision on the rerouting of the communication link can be made on the basis of a comparison of link parameters for the communication link, such as for example on the basis of a comparison of the expected transmitter powers or the expected traffic loads for the radio communication systems available as alternatives. This can be used to minimize the additional loading resulting for the particular radio communication system.

To enable a particularly effective method for the rerouting of the communication link, it can be provided that the rerouting of the communication link takes place by access to address tables that place address data of the subscriber terminals in relation to each other the different radio communication systems. The subscriber terminals are thus already assigned corresponding address data within the alternate radio communication system before a possible rerouting of a communication link via an alternate radio communication system, and a clear mutual assignment of this address data takes place within the framework of address tables, in order to facilitate the provision of alternate link paths.

The address data of the subscriber terminals can be exchanged between address memories of the radio communication systems, either regularly or based on events, to generate the address tables. Such address memories can, for example, be held in suitable central units of the radio communication system, such as switching centers. The event-controlled exchange can, for example, take place when a subscriber terminal is initially brought into service in one of the radio communication systems, when a subscriber terminal is changed between subunits of a radio communication system or after interruption in the link between the subscriber terminal and radio communication system, or after an interruption in the link between radio communication systems themselves.

A particularly advantageous type of addressing of subscriber terminals provides for the address data of the subscriber terminals to be formed in at least one of the radio communication systems by a combination of address data (e.g. a prefix) for identification of a local subunit of a radio communication system and other address data for identification of the subscriber terminal within the local subunit of the radio communication system. This means that within the local subunit of a radio communication system it is sufficient to address the subscriber terminal using only the part of the address data that identifies the subscriber terminal itself. The part of the address data that identifies the local subunit can be omitted within the local subunit.

As already stated, it can be provided that a rerouting of the communication link can take place either completely, or also only partially, via an alternate radio communication system, i.e. that the rerouting of the communication link can take place exclusively via devices of a radio communication system or the rerouting of the communication link can take place via devices of several radio communication system.

In principle, all types of radio communication systems can be provided as alternate radio communication systems. In a special form of embodiment of the invention, at least one ad-hoc radio communication system and at least one cellular radio communication system are used as communication systems.

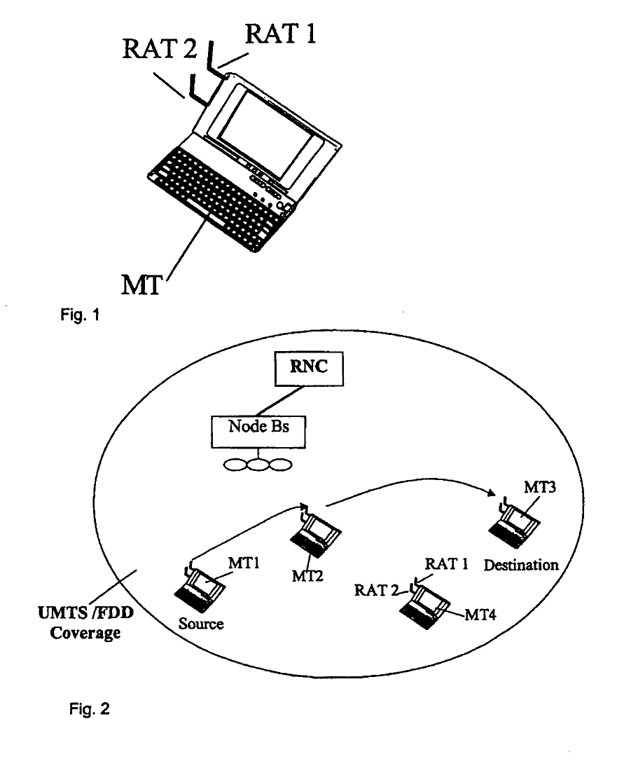

A special example of an embodiment of this invention is explained in the following with the aid of FIGS. 1 to 9.

The illustrations are as follows.

FIG. 1: Representation of a dual-mode subscriber terminal.

FIG. 2: Schematic representation of a communication link in an ad-hoc radio communication system.

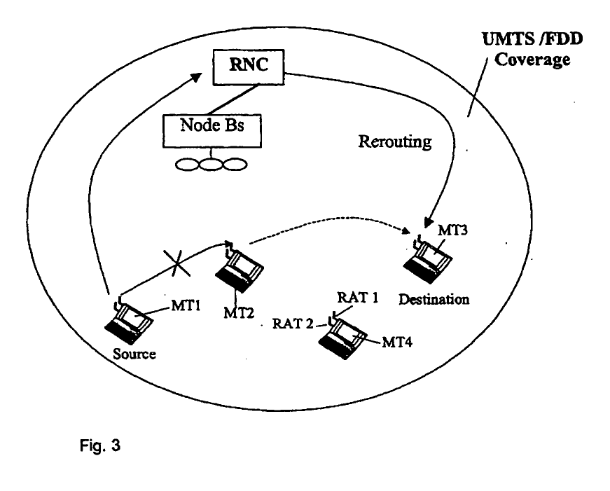

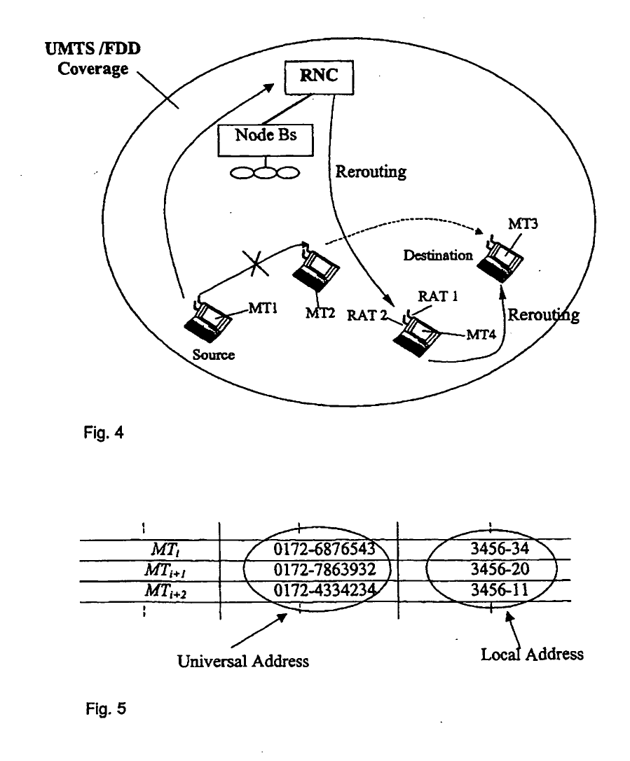

FIGS. 3 and 4: Rerouting of a communication link via alternate communication paths.

FIG. 5: Representation of an improved addressing of the subscriber terminals.

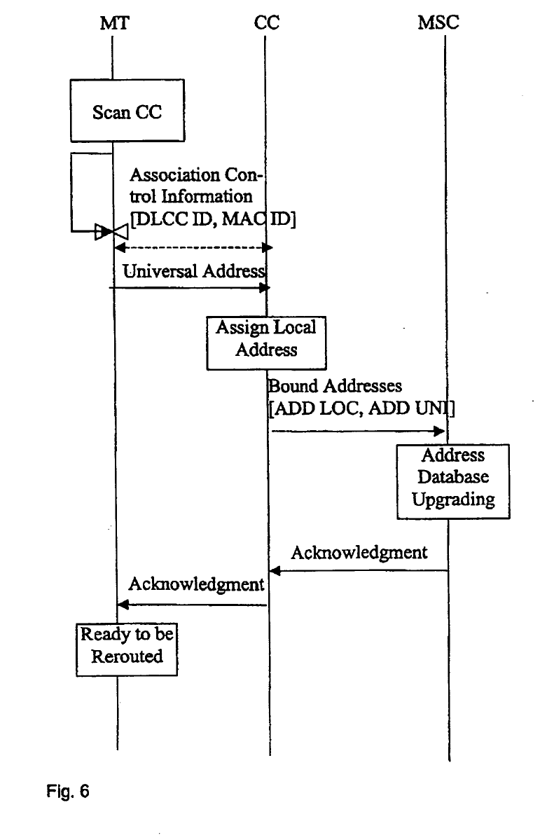

FIG. 6: Signaling sequence of the transmission of local address data between a subscriber terminal, control unit of an ad-hoc system and switching center of a cellular system.

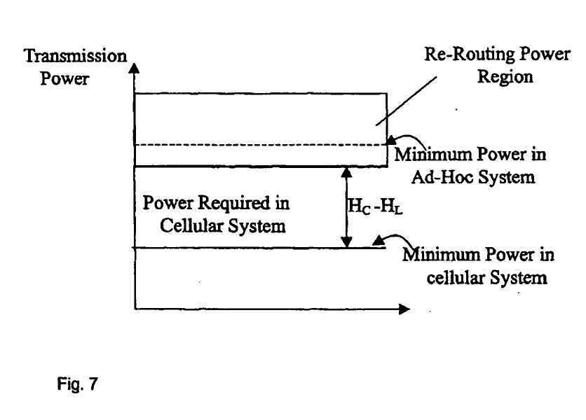

FIG. 7: Schematic representation of the relationship between the minimum required transmission power of different radio communication systems.

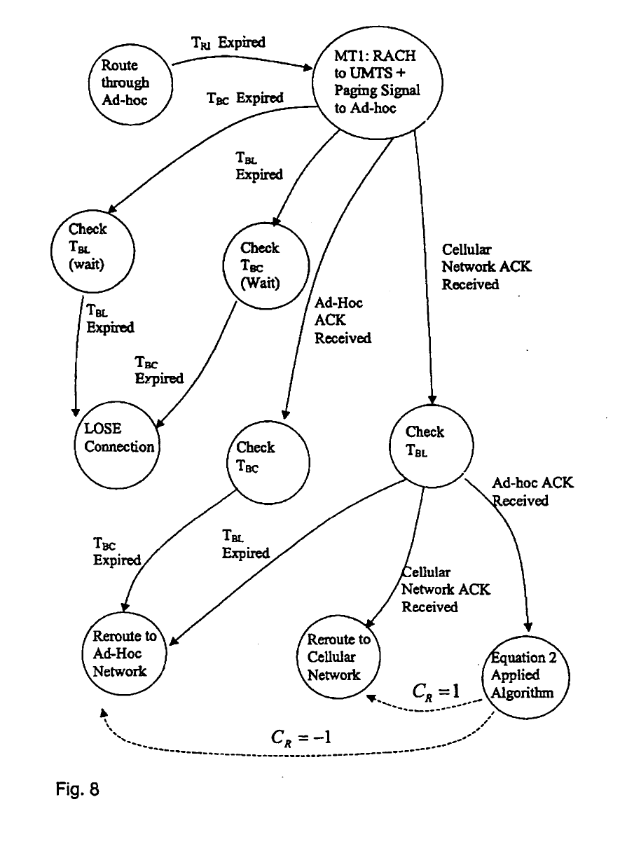

FIG. 8: Decision diagram for a specific communication path for rerouting a communication link.

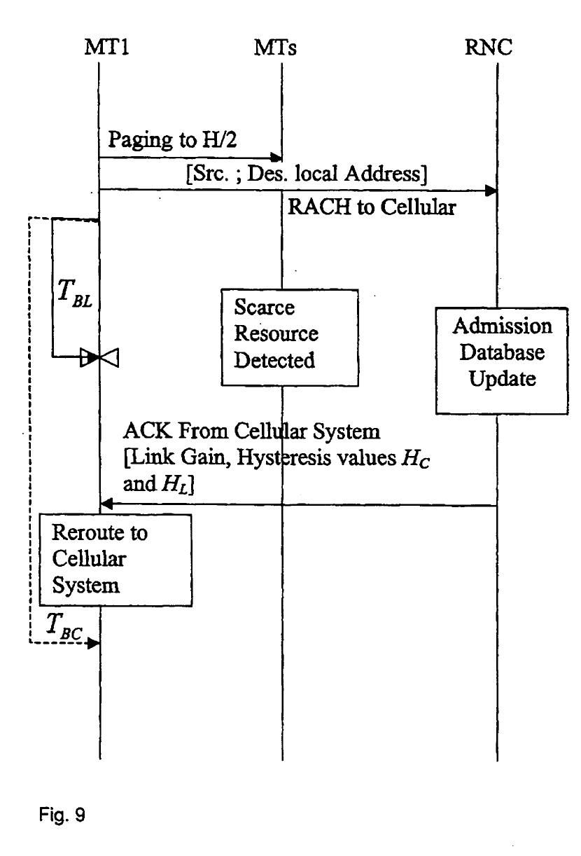

FIG. 9: Example of a signaling sequence for the method in accordance with FIG. 8.

FIG. 1 shows a dual-mode subscriber terminal MT that can access two radio communication systems with different radio access techniques, for example an ad-hoc radio communication system in the form of a wireless local area network WLAN, such as the HIPERLAN/2 or IEEE802.11 system and a cellular radio communication system, for example to the GSM standard or the UMTS standard such as a UMTS/FDD system. For this purpose, the subscriber MT has a first device RAT1 for access (radio access) to the ad-hoc radio communication system and a second device RAT2 for access to the cellular radio communication system. The subscriber terminal can thus access two different radio communication systems via two different radio interfaces.

FIG. 2 shows an ad-hoc radio communication system with subscriber terminals MT1 to MT4 in which an existing communication link from a source terminal MT1 is routed via a further subscriber terminal MT2 of the ad-hoc radio communication system to a destination terminal MT3. All the subscriber terminals MT1 to MT4 are within range of an UMTS/FDD communication system (UMTS/FDD coverage) at the same time, so that in principle, access to the cellular UMTS/FDD communication system is also possible for subscriber terminals MT1 to MT4.

FIGS. 3 and 4 show a case where the existing ad-hoc communication link, shown in FIG. 2, between the subscriber terminal MT1 (source) and MT3 (destination) is interrupted on the path between the subscriber terminals MT1 and MT2. It is now possible to reroute the link via an alternate communication path, whereby this can take place, in accordance with this invention, by using the UMTS/FDD system. A rerouting of the communication link via the UMTS/FDD radio communication system does not necessarily take place automatically, but instead this decision can be made dependent on several parameters.

Thus, a request to establish a communication link in the form of RACH data (RACH burst) can first be sent to the UMTS/FDD system and, parallel to this, a similar request in the form of a paging signal can be sent within the ad-hoc radio communication system. A decision as to whether a new communication path (rerouting) is best for rerouting the communication link can therefore be made depending on whether, and with what content, the responses are received from the corresponding radio communication systems. In particular, it can be provided that a communication link can be established via the UMTS/FDD system if the anticipated response from the ad-hoc radio communication system is either not received, or not received in time. If, however, responses from both radio communication systems are present, the communication path that offers the best advantage for the complete system can then be judged. This is explained in more detail in the following with the aid of FIG. 8.

As FIGS. 3 and 4 show, when rerouting the communication link via an alternate communication path using the UMTS/FDD system, it can be provided either that the alternate communication link is rerouted exclusively within the UMTS/FDD system (FIG. 3), so that in turn only devices of a single radio communication system are involved, or it can be provided that the alternate communication link (rerouting) takes place within the UMTS/FDD system merely up to a further subscriber terminal MT4 of the ad-hoc radio communication system (FIG. 4), that is also equipped with devices RAT1, RAT2 for access both to the ad-hoc radio communication system and to the cellular UMTS/FDD system and thus act as switching nodes for the rerouting of the communication link. The alternate communication link (rerouting) to the destination subscriber terminal MT3 can take place from this subscriber terminal within the ad-hoc radio communication system.

As already mentioned, different parameters can be taken into account as a basis for a decision and/or for an effective establishment of an alternate communication path. Such parameters are preferably time information of the time duration up to a response from the radio communication system to a request by the subscriber terminal MT1. Maximum time durations defined by timers can be provided for this purpose, with in this case T_{BL} being the time duration for a response by the ad-hoc radio communication system and T_{BC} the time duration for a response from the cellular UMTS/FDD system.

If several alternate communication paths are possible, a cost function for the possible alternate communication links can also be considered as a basis for the decision for one or other radio communication system or for one or more possible communication paths within a radio communication system, i.e. parameters that provide information on which possible alternate communication links require the least expense or afford the greatest benefit.

One such parameter is the link gain, i.e. the inverse of the path loss along the communication path. The link gain is associated with the required transmitter power for this communication link, so that the less the path loss the less transmitter power is required. The additional interference resulting due to the alternate communication link should be minimized as far as possible for the relevant radio communication system by taking account of this parameter. Similarly, the additional traffic load relative to the already existing traffic load in the particular radio communication system due to the alternate communication link can also be taken into account as a further parameter. The decision on rerouting the communication link through a certain radio communication system of several possible systems can also be based on a parameter for the quality of the alternate communication link (quality of service QoS).

The following shows an example of the aforementioned decision scenario. This example assumes G_{L} to be the link gain in the ad-hoc system and G_{C} the link gain in the cellular UMTS/FDD system. As already explained, the required transmitter power is reduced in line with the reduction in path losses, i.e. the higher the link gain. This can be expressed by the following equation.

$$\{ \begin{matrix}{P}_{T \times L} + {G}_{L} = {P}_{R \times L} \\ {P}_{T \times c} + {G}_{C} = {P}_{R \times C}\end{matrix} \qquad ( 1 )$$

whereby P_{T×L} is the minimum required transmitter power and P_{R×L} is the minimum required receiver power in the ad-hoc system, and P_{T×C} and P_{R×C} represent the corresponding parameters for the cellular UMTS/FDD system. For the decision process to decide the rerouting of a communication link, the variables on the right side of the equation (1) can be replaced by the reception powers anticipated for the alternate communication links. From these, the expected, minimum required transmission powers can also be determined by means of equation (1).

Because of the direct interaction between the transmitter power and the demands for maximum load in a radio communication system, a decision algorithm for a certain communication path for rerouting a communication link can be described in the form of the following equation
C_{R}=sign[P_{T×L}+H_{L}−(P_{T×C}+H_{C})] (2)
whereby H_{L} is a rerouting hysteresis for the ad-hoc system and H_{C} is a routing hysteresis for the cellular UMTS/FDD system for the selection of a communication path, that is designed to prevent a continuous jumping backwards and forwards between several approximately equal communication paths (ping-pong effect). C_{R} is the command for selecting a certain communication path. C_{R} is initially set to the value −1 in the cases shown in FIGS. 3 and 4, to indicate that the corresponding communication link originally ran within the ad-hoc system. If after an interruption in the communication link in the ad-hoc system and a renewed calculation of equation (2) the result is that C_{R} now assumes the value +1, the communication link is then routed via the cellular UMTS/FDD system.

To explain this algorithm for selecting between several radio communication systems for the setting up of a communication path, FIG. 7 shows the relationship between the minimum required transmitter power, resulting from the link gains according to equation (1) and the two values for the rerouting hysteresis. In particular, FIG. 7 shows the particular region for the transmitter power in which a communication path is set up in the cellular UMTS/FDD system. The precondition under which equation (2) is used in the context of the method in accordance with the invention is explained in FIG. 8.

To be able to specify suitable values H for the rerouting hysteresis, the parameters must take account of the system load of the particular radio systems. The parameters of the system load describe the actual load (e.g. relative to the traffic load, the interference situation, the transmitter powers etc.) in the ad-hoc system or in the cellular UMTS/FDD system. The knowledge of the actual values of the parameters of the system load enables the system loads occurring to the possible alternate communication paths, that could be considered for the rerouting of a communication link, to be predicted. The system loads are taken into account by an access algorithm of the relevant communication system in each of the radio communication systems, or in each local subunit of a radio communication system, that could possibly be considered.

Immediately a communication path in a radio communication system or corresponding subunit has been permitted, the interrupted communication link is rerouted via this alternate communication path. In doing so, the value H for the corresponding hysteresis can be adapted using the information on which the access algorithm is based. The value H for the rerouting hysteresis depends on the system loads in both radio communication systems: the higher the system load in specific radio communication system the lower the corresponding value of H for the corresponding rerouting hysteresis. It is thus easier to change the communication path for rerouting the communication link via an alternate communication path by using an alternate radio communication system.

A decision diagram for a certain communication path for rerouting a communication link, that takes account of the aforementioned method steps, is shown in FIG. 8. It is assumed that a communication link starting from subscriber terminal MT1 passes through the ad-hoc system. After a time T_{RI} has elapsed, the subscriber terminal MT1 determines that the communication link has been interrupted. The subscriber terminal MT1 then sends the RACH requests and paging signal to both radio communication systems.

The subscriber terminal then calculates the response time T_{BL} of the ad-hoc system and response time T_{BC} of the cellular UMTS/FDD system. The response times can be set to different lengths so that for T_{BL} of the ad-hoc system, in particular, a shorter duration is specified than for the T_{BC} of the cellular system. If no response is received from the radio communication system in time, the communication link remains interrupted. If only one radio communication system responds within the preset time T_{BL} or T_{BC}, the communication link can be routed via this radio communication system.

If both radio communication systems respond within the preset time T_{BL} or T_{BC}, the communication path can be selected by using the algorithm according to equation (2). Therefore, in this case the link gain parameters are taken into account in addition to the response times.

An example of a signaling sequence as a method in accordance with FIG. 8 is shown in FIG. 9. A paging signal is sent from the subscriber terminal MT1 to the other subscribing terminal MT of the ad-hoc Hyperlan/2 (H/2) system, and simultaneously an RACH request is sent to the radio network controller RNC of the cellular UMTS/FDD system. In both cases, the local address data of the source terminal MT1 (source Src.) and the destination terminal (destination Des.) are also transmitted. If within the specified time T_{BL} for the ad-hoc system no acknowledgment is received from this system, a scarcity of resources is, for example, determined instead. On the contrary, in the cellular system the database of the access system is updated and a positive acknowledgment (ACK) is received within the time T_{BC} specified for the cellular system,. The communication link can therefore be rerouted via the cellular system (reroute to cellular system).

To simply as far as possible the rerouting of communication links using the ad-hoc radio communication system, an improved addressing of the subscriber terminal can be provided, as shown in FIG. 5. Subscriber terminals MT1 to MT4 each have individual address data in the form of telephone numbers, or similar, within each of the radio communication systems, i.e. universal address data within the cellular UMTS/FDD radio communication system and local address data within the ad-hoc radio communication system. The local address data can preferably consist of two parts, as shown in FIG. 5, i.e. a first part (prefix) that identifies a local subunit of the radio communication system and is identical for all subscriber terminals within the subunit and the second part that identifies the particular subscriber terminal within this subunit. Within the subunit it is then sufficient to merely use the second part of the address data to address the subscriber terminals.

The ad-hoc radio communication system is administered from a central controller (CC). The specification of this central controller is achieved by means of a suitable algorithm that selects a specific subscriber terminal as the central controller, in order to coordinate the data transmission behavior of the subscriber terminals located in the vicinity of the subscriber terminal selected as the central controller. Corresponding to the aforementioned two-part addressing of the subscriber terminals, the first part (prefix) is in each case unique for a specific central controller of the ad-hoc radio communication system.

Each subscriber terminal retains its local address data as long as it is active, i.e. as long as it is assigned to a specific central controller CC. The subscriber terminals use the local address data to identify themselves within the ad-hoc system and to set up communication links to other subscriber terminals of the ad-hoc system. The allocation of local address data, in particular the assignment for a limited time, can guarantee a considerable anonymity of the subscriber terminals within the ad-hoc system, where this is appropriate. Care must be taken when allocating the local address data that sufficient address possibilities remain for any further subscriber terminals that may be added.

As an alternative to the available radio communication systems such as cellular radio communication systems, the central controller can transmit the address data, particularly the local address data, that is coordinated by the central controller. In this case, these can be transmitted to a central address data memory or a corresponding central data administration unit (e.g. a VLR) such as a switching center (e.g. an MSC).

The address data can then be updated in response to certain events transmitted to the cellular UMTS/FDD radio communication system. If new subscriber terminals are added to the ad-hoc system, the local address data is transmitted by the control center to the corresponding device (e.g. MSC) of the UMTS/FDD system. If the link between the control center and one or more subscriber terminals is lost so that one or more subscriber terminals are no longer actively assigned to this control center, these subscriber terminals are assigned new local address data by a new control center and this new local address data is transmitted corresponding to the cellular radio communication system. In such cases, the updating of the local address data stored in the cellular radio communication system would not take place regularly, but instead on a random basis, because the deciding events also do not occur according to a regular time pattern.

FIG. 6 shows the signaling sequence of such a transmission of local address data between a subscriber terminal MT, a control center CC of the ad-hoc system and a switching center MSC of the UMTS/FDD system. After the associated control center CC is determined, the universal address data is first transmitted by the subscriber terminal MT to the control center CC. This assigns local address data ADD LOC to the subscriber terminal MT and transmits this, together with the universal address data ADD UNI, to the switching center MSC. The universal address data is transmitted in order to permit a clear assignment and updating of the address data in the switching center. For data protection reasons, the universal address data can be transmitted encrypted to the control center.

The stored data is updated in the switching center. This process is acknowledged to the control center CC, which in turn transmits an acknowledgment to the subscriber terminal MT. The conditions for a rerouting of a communication link existing within the ad-hoc system for the subscriber terminal MT using the UMTS/FDD system are thus created. The complete address data can also be transmitted back from the UMTS/FDD system to the subscriber terminal, in order to create a backup copy of the address data there, e.g. in case the control center CC loses the connection to the UMTS/FDD system. The backup copy of the address data in the subscriber terminal can then be accessed to enable rerouting of existing communication links.

For an effective access to the stored address data within the cellular radio communication system, address tables with the address data of the subscriber terminals are thus created, as is shown in FIG. 5. An address table of this kind shows the relationship of the local and universal address data of the subscriber terminals. Such address tables can be created within the cellular radio communication system using the knowledge of the transmitted local address data and the universal address data which is already present. These address tables can, for example, be stored by a switching center of the cellular radio communication system (MSC) in an assigned data administration unit (VLR). If a communication link existing in the ad-hoc system is now rerouted using the UMTS/FDD system, such as is shown by way of example in FIGS. 3 and 4, the establishment of an alternate communication path via the UMTS/FDD system is facilitated by the already existing address table.

If an existing communication link in the ad-hoc system is now interrupted for a subscriber terminal MT (in the case in FIGS. 3 and 4, the link between subscriber terminal MT1 and destination subscriber terminal MT3), a request is sent to the UMTS/FDD system, as already described, and in doing so the local address data of the affected subscriber terminal MT1 and of the destination subscriber terminal MT3 is transmitted. The switching center MSC of the UMTS/FDD system can read the universal address data of the affected subscriber terminals MT1, MT3 from the stored address table and activate a rerouting of the communication link on the basis of this information. If an alternate communication path is set up via the UMTS/FDD system, an acknowledgment is transmitted to the affected subscriber terminal MT1, together with specific parameters on the possible communication link, such as link gain parameters and hysteresis parameters.

This invention thus, in particular, provides algorithms and processing procedures for interrupted and disrupted communication links in radio communication systems, such as in ad-hoc systems. The rerouting of the communication link via an alternate communication path can then take place at any suitable point in the previous communication path. The communication path can thus leave, in particular the ad-hoc system, at any further point and re-enter the ad-hoc system at any other further point.

Furthermore, an address database can be provided in a radio communication system that covers a large area, in particular in a VLR of a cellular system, whereby the database can be updated according to the address system of the subscriber terminals of the ad-hoc system and an assignment of address data and an address management can be provided. By introducing address data, particularly for the ad-hoc system that consists of a prefix for identification of a subunit of the ad-hoc system and address data for an identification of the subscriber terminals MT, the setting up of alternate communication paths (rerouting) can be made easier. By introducing defined time durations and hysteresis values or similar parameters, a further choice can be made between several alternate communication paths and this communication path can be stabilized, i.e. a frequent changing of communication paths (ping-pong effect) can be prevented.

1-12. (canceled)

13. A method for rerouting an existing communication link with a subscriber terminal configured for communication with a plurality of radio communication systems, the method which comprises:
in an environment with a plurality of radio communication systems including a first radio communication system and at least one further radio communication system, and upon a disruption or interruption of the existing communication link to the first radio communication system, initiating a rerouting of the communication link to the further radio communication system;
prior to the rerouting of the communication link with the further radio communication system, assigning address data respectively associated with the subscriber terminal to each other in at least one address table in the plurality of radio communication systems.

14. The method according to claim 13, which comprises, after a disruption or interruption of the existing communication link, issuing requests for rerouting of the communication link in parallel via the first radio communication system and at least one further radio communication system.

15. The method according to claim 14, which comprises effecting a decision on the rerouting of the communication link using the at least one further radio communication system under control of time information.

16. The method according to claim 15, which comprises taking the decision regarding the rerouting of the communication link in dependence on a time duration until a response to the requests is obtained from the radio communication systems.

17. The method according to claim 16, which comprises rendering a decision on the rerouting of the communication link additionally in dependence on a comparison of connection parameters for the communication link.

18. The method according to claim 14, which comprises rendering a decision on the rerouting of the communication link in dependence on a comparison of connection parameters for the communication link.

19. The method according to claim 18, wherein, when a response is obtained from several radio communication systems within a defined time period, rendering a decision regarding the rerouting of the communication link in dependence on transmission power data for the communication link.

20. The method according to claim 13, which comprises generating address tables by exchanging address data of subscriber terminals between address memories of the radio communication systems.

21. The method according to claim 20, which comprises exchanging the address data regularly.

22. The method according to claim 20, which comprises exchanging the address data controlled according to events.

23. The method according to claim 13, which comprises generating the address data of the subscriber terminals in at least one of the radio communication systems by combining address data for identification of a local subunit of the radio communication system and other address data for identification of the subscriber terminal within the local subunit of the radio communication system.

24. The method according to claim 13, which comprises rerouting the communication link with equipment of one of the radio communication systems.

25. The method according to claim 13, which comprises rerouting the communication link with devices of several radio communication systems.

26. The method according to claim 13, wherein the plurality of radio communication systems include at least one ad-hoc radio communication system and at least one cellular radio communication system.
